(19) United States
(12) Patent Application Publication
(10) Pub. No.: US 2014/0113082 A1
(43) Pub. Date: Apr. 24, 2014

(54) INK-JET PRINTING INK AND PRINTING METHOD

(71) Applicant: MIMAKI ENGINEERING CO., LTD., Tomi-city (JP)

(72) Inventor: Masaru OHNISHI, Tomi-city (JP)

(73) Assignee: MIMAKI ENGINEERING CO., LTD., Tomi-city (JP)

(21) Appl. No.: 14/052,780

(22) Filed: Oct. 14, 2013

(30) Foreign Application Priority Data
Oct. 24, 2012 (JP) 2012-235094

(51) Int. Cl. C09D 11/00

(52) U.S. Cl. CPC C09D 11/38
USPC 427/511; 524/720; 524/770; 524/775

(57) ABSTRACT

Not only the applied ink has improved weathering resistance after the printing, but also the ink can be advantageously cured during the printing. A printing method having: an ink application step for applying an ultraviolet curing ink onto a recording medium, wherein the ultraviolet curing ink contains an ultraviolet light absorber having a transmittance with respect to an ultraviolet light having a wavelength of 360 nm or more, which is higher than a transmittance with respect to an ultraviolet light having a wavelength of less than 360 nm; and an ultraviolet light irradiation step for irradiating the ink on the recording medium with an ultraviolet light having a wavelength of from 365 to 410 nm from an LED.

This application claims the benefit of Japanese Patent Application No. 2012-235094, filed on Oct. 24, 2012, which is hereby incorporated by reference as if fully set forth herein.

### BACKGROUND OF THE INVENTION

1. Field of the Invention

The present invention relates to an ink-jet printing ink and a printing method.

2. Description of the Background Art

In ink-jet printing using an ultraviolet curing ink, an ultraviolet curing ink is applied onto a recording medium to form an ink layer, and the ink layer is irradiated with an ultraviolet light to cure the ink layer. As an ink-jet printing method using such an ultraviolet curing ink, for example, the printing method described in JP-A-2004-358769 (published on Dec. 24, 2004) has been known.

Printed materials printed using an ultraviolet curing ink have a problem in that they suffer decoloring of pigments due to deterioration caused by an ultraviolet light or oxidation caused by ozone or the like. When an ultraviolet light absorber is incorporated into the ultraviolet curing ink for solving the above problem, another problem arises in that the ultraviolet light absorber inhibits the ultraviolet curing ink from being cured during the printing.

### SUMMARY OF THE INVENTION

In view of the above problems, the present invention has been made, and a primary object of the invention is to provide an ink-jet printing ink and a printing method, which are advantageous not only in that the applied ink has improved weathering resistance after the printing, but also in that the ink can be advantageously cured during the printing.

The printing method of the invention comprises: an ink application step for applying an ultraviolet curing ink onto a recording medium, wherein the ultraviolet curing ink contains an ultraviolet light absorber having a transmittance with respect to an ultraviolet light having a wavelength of 360 nm or more, which is higher than a transmittance with respect to an ultraviolet light having a wavelength of less than 360 nm; and an ultraviolet light irradiation step for irradiating the ink on the recording medium with an ultraviolet light having a wavelength of from 365 to 410 nm from an LED.

In the above-mentioned construction, in the ink application step, an ultraviolet curing ink is applied onto a recording medium to form an ink layer. Then, in the ultraviolet light irradiation step, the ultraviolet curing ink applied onto the recording medium in the ink application step is irradiated with an ultraviolet light having a wavelength of from 365 to 410 using an LED.

The ultraviolet curing ink applied in the ink application step contains an ultraviolet light absorber, and the ultraviolet light absorber has a transmittance with respect to an ultraviolet light having a wavelength of 360 nm or more, which is higher than a transmittance with respect to an ultraviolet light having a wavelength of less than 360 nm. Therefore, in the ultraviolet light irradiation step, the ultraviolet light emitted from an LED is not absorbed by the ultraviolet light absorber but transmitted to advantageously cure the ink on the recording medium. On the other hand, an ultraviolet light having a wavelength of less than 360 nm is absorbed by the ultraviolet light absorber, so that the applied ink can be prevented from suffering deterioration due to an ultraviolet light after the printing.

The printing method of the invention comprises: a first ink application step for applying an ultraviolet curing ink onto a recording medium; a first ultraviolet light irradiation step for irradiating the ultraviolet curing ink applied onto the recording medium with an ultraviolet light; a second ink application step for, after the first ultraviolet light irradiation step, applying an ultraviolet curing ink onto the ultraviolet curing ink irradiated with the ultraviolet light; and a second ultraviolet light irradiation step for irradiating the ultraviolet curing ink applied in the second ink application step with an ultraviolet light, wherein the ultraviolet curing ink applied in at least one step of the first ink application step and the second ink application step contains an ultraviolet light absorber having a transmittance with respect to an ultraviolet light having a wavelength of 360 nm or more, which is higher than a transmittance with respect to an ultraviolet light having a wavelength of less than 360 nm, wherein, among the first ultraviolet light irradiation step and the second ultraviolet light irradiation step, in the step of irradiating the ultraviolet curing ink containing the ultraviolet light absorber with an ultraviolet light, the ultraviolet curing ink is irradiated with an ultraviolet light having a wavelength of from 365 to 410 nm from an LED.

In the above-mentioned construction, in the first ink application step and first ultraviolet light irradiation step, the first ink layer is formed and then, in the second ink application step and second ultraviolet light irradiation step, the second ink layer is formed on the first ink layer. The ultraviolet curing ink applied in at least one step of the first ink application step and the second ink application step contains an ultraviolet light absorber having a transmittance with respect to an ultraviolet light having a wavelength of 360 nm or more, which is higher than a transmittance with respect to an ultraviolet light having a wavelength of less than 360 nm, and the ultraviolet curing ink containing the ultraviolet light absorber is irradiated with an ultraviolet light having a wavelength of from 365 to 410 nm from an LED.

Thus, in the ultraviolet light irradiation step, the ultraviolet light emitted from an LED is not absorbed by the ultraviolet light absorber but transmitted to advantageously cure the ink on the recording medium. On the other hand, an ultraviolet light having a wavelength of less than 360 nm is absorbed by the ultraviolet light absorber, so that the applied ink can be prevented from suffering deterioration due to an ultraviolet light after the printing.

Further, for example, when forming the first ink layer from an ultraviolet curing ink containing a pigment and forming the second ink layer from an ultraviolet curing ink containing no pigment, the second ink layer functions as a clear coat, making it possible to prevent the pigment present in the first ink layer from suffering oxidation due to ozone or the like.

In the printing method of the invention, it is preferred that the ultraviolet light absorber is at least one member selected from the group consisting of a benzotriazole ultraviolet light absorber, a liquid ultraviolet light absorber, a triazine ultraviolet light absorber, a benzophenone ultraviolet light absorber, and a benzoate ultraviolet light absorber.

By virtue of the above-mentioned construction, there can be advantageously constructed an ultraviolet curing ink which is advantageous not only in that the ink can be advantageously cured by irradiation with an ultraviolet light during the printing, but also in that the applied ink can be prevented from suffering deterioration due to an ultraviolet light after the printing.

In the printing method of the invention, it is preferred that the ultraviolet curing ink contains a diluent in an amount of 20% by weight or more, based on the weight of the ink.

By virtue of the above-mentioned construction, the ultraviolet curing ink has a preferred viscosity such that the cured ink layer has an advantageous hardness.

The ink-jet printing ink of the invention contains an ultraviolet curing resin, and an ultraviolet light absorber having a transmittance with respect to an ultraviolet light having a wavelength of 360 nm or more, which is higher than a transmittance with respect to an ultraviolet light having a wavelength of less than 360 nm.

By virtue of having the above-mentioned construction, the ink-jet printing ink can be advantageously used in the printing method of the invention.

The invention exhibits effects such that the ultraviolet curing ink can be effectively cured while being improved in weathering resistance by an ultraviolet light absorber.

### BRIEF DESCRIPTION OF THE DRAWINGS

FIGS. 1A to 1E are explanatory views of a printing method according to one embodiment of the invention; and

FIGS. 2A to 2C are explanatory views of one form of a printed material printed by the printing method of the invention.

### DETAILED DESCRIPTION OF THE INVENTION

(Printing Method)

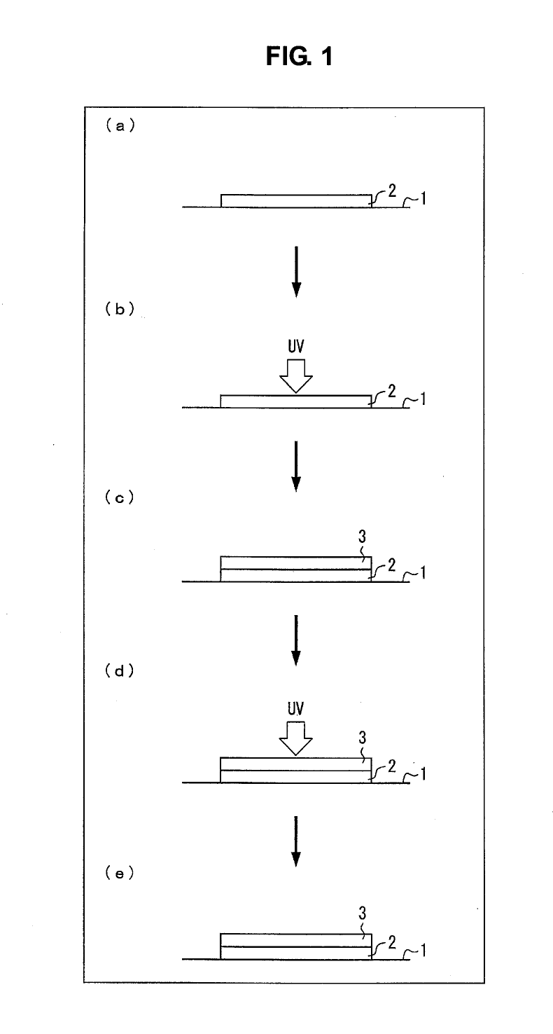

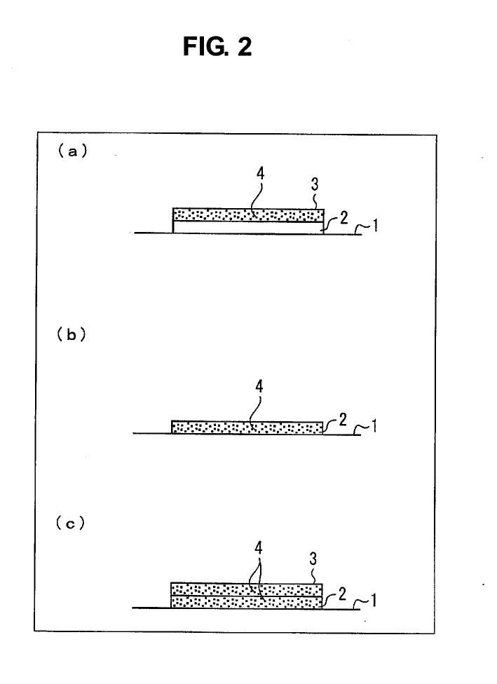

Hereinbelow, a printing method according to one embodiment of the present invention is descried with reference to FIGS. 1A to 2C. FIGS. 1A to 1E are explanatory views of the printing method according to one embodiment of the invention. The printing method according to one embodiment of the invention comprises an ink application step for applying an ultraviolet curing ink containing an ultraviolet light absorber onto a recording medium, and an ultraviolet light irradiation step for irradiating the ink on the recording medium with an ultraviolet light.

(First Ink Application Step)

In a first ink application step (ink application step), as shown in FIG. 1A, an ultraviolet curing ink is applied onto a recording medium 1 to form an ink layer 2. The ultraviolet curing ink applied in the first ink application step contains an ultraviolet light absorber having a transmittance with respect to an ultraviolet light having a wavelength of 360 nm or more, which is higher than a transmittance with respect to an ultraviolet light having a wavelength of less than 360 nm.

As the ultraviolet light absorber, a known ultraviolet light absorber can be used, but preferred is at least one ultraviolet light absorber selected from the group consisting of a benzotriazole ultraviolet light absorber, a liquid ultraviolet light absorber, a triazine ultraviolet light absorber, a benzophenone ultraviolet light absorber, and a benzoate ultraviolet light absorber. By incorporating the above ultraviolet light absorber into the ultraviolet curing ink, there can be advantageously constructed the ultraviolet curing ink used in the printing method according to the present embodiment. The ultraviolet curing ink used in the printing method according to the present embodiment is described in detail later.

As a method for applying the ultraviolet curing ink in the first ink application step, a conventionally known method can be used. For example, the ultraviolet curing ink can be applied using a known ink-jet printing apparatus.

(First Ultraviolet Light Irradiation Step)

In a first ultraviolet light irradiation step (ultraviolet light irradiation step), as shown in FIG. 1B, the ink layer 2 on the recording medium 1 is irradiated with an ultraviolet light to cure the ink layer 2. In the first ultraviolet light irradiation step, the ink layer 2 is irradiated with an ultraviolet light having a wavelength of from 365 to 410 nm, preferably from 380 to 410 nm, from an LED.

The ultraviolet light absorber contained in the ultraviolet curing ink forming the ink layer 2 has a transmittance with respect to an ultraviolet light having a wavelength of 360 nm or more, which is higher than a transmittance with respect to an ultraviolet light having a wavelength of less than 360 nm. Therefore, the ultraviolet light having a wavelength in the above range emitted in the first ultraviolet light irradiation step is not absorbed by the ultraviolet light absorber contained in the ultraviolet curing ink but transmitted to advantageously cure the ink layer 2. On the other hand, the ultraviolet light absorber advantageously absorbs an ultraviolet light having a wavelength of less than 360 nm, so that the cured ink layer 2 (after the printing) can be prevented from suffering deterioration due to an ultraviolet light.

In the first ultraviolet light irradiation step, the ultraviolet curing ink is irradiated with an ultraviolet light having a wavelength of from 365 to 410 nm, preferably from 380 to 410 nm, using an LED. By irradiating the ultraviolet curing ink with an ultraviolet light having a wavelength in the above range using an LED, the ultraviolet curing ink can be cured without being inhibited by the ultraviolet light absorber. Further, the use of an LED in the ultraviolet light irradiation enables the wavelength of ultraviolet light to fall within a desired narrow range, so that efficient ultraviolet light irradiation can be achieved without causing an energy loss due to irradiation with a light having a wide range of wavelength distribution as caused when using a metal halide lamp.

With respect to the ultraviolet light emitted from an LED, a quantity of light is a product of an intensity of light and an irradiation time and is represented by the formula: “Quantity of light=Intensity of light×Irradiation time”. In the first ultraviolet light irradiation step, the quantity of light in the irradiation of the ink layer 2 may be controlled by adjusting the time during which an LED head unit having a predetermined intensity of light scans the ink layer 2.

In the present embodiment, when only one ink layer (only the ink layer 2) is formed on the recording medium 1, only the first ink application step and first ultraviolet light irradiation step shown in FIGS. 1A and 1B can be performed, completing the process. In this case, into the ultraviolet curing ink forming the ink layer 2 may be incorporated a pigment as well as the above-mentioned ultraviolet light absorber.

(Second Ink Application Step)

In the present embodiment, when the second ink layer is further formed on the ink layer 2, after the above-mentioned first ultraviolet light irradiation step, an ultraviolet curing ink is applied onto the ink layer 2 as shown in FIG. 1C in a second ink application step to form the second ink layer 3. In the second ink application step, a method for applying the ultraviolet curing ink is the same as that in the first ink application step.

(Second Ultraviolet Light Irradiation Step)

In a second ultraviolet light irradiation step, as shown in FIG. 1D, the ink layer 3 formed on the ink layer 2 is irradiated with an ultraviolet light. Thus, the ink layer 3 is cured, obtaining a printed material, as shown in FIG. 1E, having two layers, i.e., the ink layer 2 and ink layer 3 formed on the recording medium 1.

When two ink layers are formed on the recording medium 1 as shown in FIGS. 1A to 1E, the ultraviolet curing ink forming at least one of the ink layer 2 and the ink layer 3 contains an ultraviolet light absorber having a transmittance with respect to an ultraviolet light having a wavelength of 360 nm or more, which is higher than a transmittance with respect to an ultraviolet light having a wavelength of less than 360 nm. Specifically, only the ultraviolet curing ink applied in the first ink application step contains the ultraviolet light absorber, only the ultraviolet curing ink applied in the second ink application step contains the ultraviolet light absorber, or the ultraviolet curing inks applied in both the first ink application step and the second ink application step contain the ultraviolet light absorber.

Among the first ultraviolet light irradiation step and the second ultraviolet light irradiation step, in the step of irradiating the ultraviolet curing ink containing the ultraviolet light absorber with an ultraviolet light, the ultraviolet curing ink is irradiated with an ultraviolet light having a wavelength of from 365 to 410 nm, preferably from 380 to 410 nm, from an LED. Specifically, when the ultraviolet curing ink containing the ultraviolet light absorber is applied in the first ink application step, the ultraviolet curing ink is irradiated with an ultraviolet light having a wavelength in the above range in the first ultraviolet light irradiation step. When the ultraviolet curing ink containing the ultraviolet light absorber is applied in the second ink application step, the ultraviolet curing ink is irradiated with an ultraviolet light having a wavelength in the above range in the second ultraviolet light irradiation step. When the ultraviolet curing ink containing the ultraviolet light absorber is applied in both the first ink application step and the second ink application step, the ultraviolet curing ink is irradiated with an ultraviolet light having a wavelength in the above range in both the first ultraviolet light irradiation step and the second ultraviolet light irradiation step.

Thus, only the ink layer 2, only the ink layer 3, or both the ink layer 2 and ink layer 3 can be formed from the ultraviolet curing ink containing the ultraviolet light absorber, and not only can these ink layers be advantageously cured by irradiation with an ultraviolet light during the printing, but also the cured ink layers can be prevented from suffering deterioration due to an ultraviolet light after the printing.

Further, for example, when forming the first ink layer 2 from an ultraviolet curing ink containing a pigment and forming the second ink layer 3 from an ultraviolet curing ink containing no pigment, the second ink layer functions as a clear coat, making it possible to prevent the pigment present in the first ink layer from suffering oxidation due to ozone or the like.

When forming the first ink layer 2 from an ultraviolet curing ink containing a pigment and containing no ultraviolet light absorber and forming the second ink layer 3 from an ultraviolet curing ink containing an ultraviolet light absorber and containing no pigment, both deterioration of the ink layer 2 due to an ultraviolet light and oxidation of the ink layer 2 due to ozone or the like can be prevented by the ink layer 3, and further an advantage is obtained in that the amount of the ultraviolet light absorber used can be reduced.

Alternatively, a procedure can be conducted in which the first ink application step and the second ink application step are continuously performed, and then both the ink layer 2 and ink layer 3 on the recording medium 1 are irradiated with an ultraviolet light to cure the ink layer 2 and ink layer 3 at the same time.

As mentioned above, by the printing method according to one embodiment of the invention, not only can the ultraviolet curing ink be improved in weathering resistance by the ultraviolet light absorber, but also the ultraviolet curing ink can be effectively cured.

By the printing method of the invention, for example, a printed material as shown in FIG. 2 can be obtained.

As shown in FIG. 2A, in the printing method of the invention, the ink layer 2 can be formed from a color ink containing no ultraviolet light absorber 4, and the ink layer 3 can be formed from a clear ink containing the ultraviolet light absorber 4. In this case, even when the ultraviolet light absorber 4 is not contained in the ink layer 2, the ink layer 2 can be effectively prevented by the ultraviolet light absorber 4 contained in the ink layer 3 from suffering deterioration due to an ultraviolet light. Further, even when a clear ink forming the ink layer 3 is applied in the second ink application step at the stage in which the ink layer 2 is not completely cured, the ultraviolet light absorber 4 contained in the clear ink does not inhibit the ink layer 2 from being cured, so that both the ink layer 2 and ink layer 3 can be advantageously cured in the subsequent second ultraviolet light irradiation step.

As shown in FIG. 2B, there can be obtained a printed material having only one ink layer, i.e., having the ink layer 2 formed from a color ink containing the ultraviolet light absorber 4 and having no ink layer 3. In this case, the ultraviolet light absorber 4 contained in the ink layer 2 can advantageously prevent the ink layer 2 from suffering deterioration due to an ultraviolet light, and therefore there is no need to separately provide a coating layer.

Further, as shown in FIG. 2C, both the color ink forming the ink layer 2 and the clear ink forming the ink layer 3 can contain the ultraviolet light absorber 4. In this case, the ultraviolet light absorber 4 is contained in both the ink layer 2 and ink layer 3, and therefore not only can these ink layers be advantageously cured by irradiation with an ultraviolet light during the printing, but also the cured ink layers can be more effectively prevented from suffering deterioration due to an ultraviolet light after the printing.

(Ink-Jet Printing Ink)

An ink-jet printing ink according to an embodiment of the present invention is an ultraviolet curing ink, and contains an ultraviolet curing resin, and an ultraviolet light absorber having a transmittance with respect to an ultraviolet light having a wavelength of 360 nm or more, which is higher than a transmittance with respect to an ultraviolet light having a wavelength of less than 360 nm. This ultraviolet curing ink can be advantageously used in the above-mentioned printing method of the invention.

The ultraviolet curing ink according to an embodiment of the invention can be formed by incorporating into an ultraviolet curing resin an ultraviolet light absorber having a transmittance with respect to an ultraviolet light having a wavelength of 360 nm or more, which is higher than a transmittance with respect to an ultraviolet light having a wavelength of less than 360 nm, together with, for example, a photopolymerization initiator, a pigment, a diluent, or the like. If necessary, the ultraviolet curing ink may contain a sensitizer, an anti-foaming agent, a polymerization inhibitor, or the like. When incorporating no pigment into the ultraviolet curing ink, it is possible to form an ink layer which functions as the above-mentioned clear coat.

(Ultraviolet Curing Resin)

The ultraviolet curing resin contained in the ultraviolet curing ink can be a monomer, oligomer, or polymer, which initiates polymerization to be cured. As such a monomer, oligomer, or polymer, a conventionally known, commercially available product can be advantageously used.

Examples of the monomers, oligomers, or polymers which initiate polymerization by irradiation with an ultraviolet light to be cured include those of cationically polymerizable type, those of radically polymerizable type, and mixtures thereof. These ultraviolet curing resins can be used individually or in combination of two or more types.

With respect to the viscosity of the monomer, oligomer, or polymer, which initiates polymerization by irradiation with an ultraviolet light, one having a viscosity appropriately selected according to the purpose may be used. For example, a monomer or oligomer having a low viscosity or those having a high viscosity may be used.

(Ultraviolet Light Absorber)

The ultraviolet curing ink contains an ultraviolet light absorber. The ultraviolet light absorber contained in the ultraviolet curing ink is an ultraviolet light absorber having a transmittance with respect to an ultraviolet light having a wavelength of 360 nm or more, which is higher than a transmittance with respect to an ultraviolet light having a wavelength of less than 360 nm. By incorporating the ultraviolet light absorber into the ultraviolet curing ink, not only can the ultraviolet curing ink be improved in weathering resistance to prevent deterioration of the ink due to an ultraviolet light after the printing, but also the ultraviolet curing ink can be advantageously cured during the printing.

As the ultraviolet light absorber, a benzotriazole ultraviolet light absorber, a liquid ultraviolet light absorber, a triazine ultraviolet light absorber, a benzophenone ultraviolet light absorber, a benzoate ultraviolet light absorber, or the like is preferably used.

Examples of benzotriazole ultraviolet light absorbers include TINUVIN P, TINUVIN 234, TINUVIN 326, TINUVIN 328, and TINUVIN 329. Examples of liquid ultraviolet light absorbers include TINUVIN 213 and TINUVIN 571.

Examples of triazine ultraviolet light absorbers include TINUVIN 1577 ED. Examples of benzophenone ultraviolet light absorbers include CHIMASSORB 81. Examples of benzoate ultraviolet light absorbers include TINUVIN 120.

A triazine ultraviolet light absorber can advantageously absorb an ultraviolet light having a wavelength of less than 360 nm, and therefore, as the triazine ultraviolet light absorber, a hydroxyphenyltriazine ultraviolet light absorber is especially preferably used, and TINUVIN 400, TINUVIN 405, and TINUVIN 479 are preferably used. The above-mentioned TINUVIN and CHIMASSORB are registered trademarks, and all of the above products are manufactured by BASF (the former Ciba Specialty Chemicals K.K.).

These ultraviolet light absorbers can be used individually or in combination of two or more types.

It is preferred that the ultraviolet light absorber is incorporated in an amount in the range of from 0.1 to 5.0% by weight, based on the weight of the ultraviolet curing ink composition. When the amount of the ultraviolet light absorber incorporated falls within the above range, the absorber advantageously absorbs an ultraviolet light having a wavelength of less than 360 nm and does not inhibit the transmission of an ultraviolet light having a wavelength of 360 nm or more. Any ultraviolet light absorber having such properties can be preferably used.

(Photopolymerization Initiator)

The ultraviolet curing ink may contain a photopolymerization initiator. By incorporating a photopolymerization initiator into the ultraviolet curing ink, the ultraviolet curing ink can be advantageously cured by irradiation with an ultraviolet light from an LED. The type of the photopolymerization initiator can be appropriately selected depending on the type of the ultraviolet curing resin used, and two or more types of photopolymerization initiators can be used in combination. As a radical photopolymerization initiator, for example, an alkylphenone photopolymerization initiator, a thioxanthone photopolymerization initiator, an acylphosphine oxide photopolymerization initiator, and a titanocene photopolymerization initiator can be used. As a cationic photopolymerization initiator, for example, an iodonium salt photopolymerization initiator and a sulfonium salt photopolymerization initiator can be used.

Examples of alkylphenone photopolymerization initiators include 1-hydroxycyclohexyl phenyl ketone and 2-methyl-1-(4-methylthiophenyl)-2-morpholinopropan-1-one. Examples of thioxanthone photopolymerization initiators include diethylthioxanthone, 2-isopropylthioxanthone, and 2-chlorothioxanthone. Examples of acylphosphine oxide photopolymerization initiators include 2,4,6-trimethylbenzoyldiphenylphosphine oxide and bis(2,4,6-trimethyl-benzoyl)phenylphosphine oxide.

Examples of iodonium salt photopolymerization initiators include iodonium (4-methylphenyl)[4-(2-methylpropyl)phenyl]hexafluorophosphate. Examples of sulfonium salt photopolymerization initiators include bis[4-(diphenylsulfonio)phenyl]sulfide bishexafluorophosphate.

An acylphosphine oxide photopolymerization initiator advantageously absorbs an ultraviolet light having a wavelength of from 365 to 410 nm and is unlikely to cause an ultraviolet curing resin to suffer discoloration, and therefore the acylphosphine oxide photopolymerization initiator is especially preferably used. These photopolymerization initiators can be used individually or in combination of two or more types.

It is preferred that the photopolymerization initiator is incorporated in an amount in the range of from 0.05 to 10% by weight, based on the weight of the ultraviolet curing ink composition. When the amount of the photopolymerization initiator incorporated falls within the above range, the ultraviolet curing ink can be advantageously cured by irradiation with an ultraviolet light from an LED, and can be prevented from lowering in weathering resistance due to the excess residual photopolymerization initiator.

(Pigment)

The ultraviolet curing ink may contain a pigment. As examples of pigments contained in the ultraviolet curing ink, there can be mentioned black pigments, such as carbon black, and color pigments, such as anthraquinone, phthalocyanine blue, phthalocyanine green, diazo, monoazo, pyranthrone, perylene, heterocyclic yellow, quinacridone, and (thio)indigoid. Representative examples of phthalocyanine blues include copper-phthalocyanine blue and a derivative thereof (pigment blue 15). Representative examples of quinacridones include pigment orange 48, pigment orange 49, pigment red 122, pigment red 192, pigment red 202, pigment red 206, pigment red 207, pigment red 209, pigment violet 19, and pigment violet 42. Representative examples of anthraquinones include pigment red 43, pigment red 194 (perinone red), pigment red 216 (brominated pyranthrone red), and pigment red 226 (pyranthrone red). Representative examples of perylenes include pigment red 123 (vermilion), pigment red 149 (scarlet), pigment red 179 (maroon), pigment red 190 (red), pigment violet, pigment red 189 (yellow shade red), and pigment red 224. Representative examples of thioindigoids include pigment red 86, pigment red 87, pigment red 88, pigment red 181, pigment red 198, pigment violet 36, and pigment violet 38. Representative examples of heterocyclic yellows include pigment yellow 117 and pigment yellow 138. Other examples of appropriate pigments are described in The Colour Index, third edition (The Society of Dyers and Colourists, 1982).

The pigment contained in the ultraviolet curing ink preferably has an average particle diameter in the range of from 20 to 300 nm. When the average particle diameter of the pigment falls within the above range, the ultraviolet curing ink has excellent dispersion stability, and further printing with high image quality can be achieved.

It is preferred that the pigment is incorporated in an amount in the range of from 1 to 10% by weight, based on the weight of the ultraviolet curing ink composition. When the amount of the pigment incorporated falls within the above range, the ultraviolet curing ink is not inhibited by the pigment from being cured and thus can be advantageously cured by irradiation with an ultraviolet light from an LED.

(Diluent)

The ultraviolet curing ink may contain a diluent. By incorporating a diluent into the ultraviolet curing ink, it is possible to control the viscosity of the ultraviolet curing ink. Further, it is possible to control the hardness of the ink layer which is a cured product of the ultraviolet curing ink.

With respect to the diluent contained in the ultraviolet curing ink, examples of polyfunctional (meth)acrylates include (meth)acrylates of ethylene glycol, 3-butylene glycol, 1,4-butanediol, 1,5-pentanediol, 3-methyl-1,5-pentanediol, 1,6-hexanediol, neopentyl glycol, polyethylene glycol, trimethylolpropane, pentaerythritol, or dipentaerythritol. Examples of monofunctional (meth)acrylates include butyl (meth)acrylate, amyl (meth)acrylate, 2-ethylhexyl (meth)acrylate, octyl (meth)acrylate, isooctyl (meth)acrylate, isobornyl (meth)acrylate, cyclohexyl (meth)acrylate, benzyl (meth)acrylate, methoxyethyl (meth)acrylate, butoxyethyl (meth)acrylate, phenoxyethyl (meth)acrylate, nonylphenoxyethyl (meth)acrylate, glycidyl (meth)acrylate, tetrahydrofurfuryl (meth)acrylate, and diethylaminoethyl (meth)acrylate. These diluents can be used individually or in combination of two or more types.

It is preferred that the diluent is incorporated in an amount in the range of from 20 to 90% by weight, based on the weight of the ultraviolet curing ink composition. When the amount of the diluent incorporated falls within the above range, the ultraviolet curing ink has a preferred viscosity such that the cured ink layer has an advantageous hardness.

(Sensitizer)

The ultraviolet curing ink may contain a sensitizer. By incorporating a sensitizer into the ultraviolet curing ink, it is possible to cause the photopolymerization initiator to more efficiently initiate a reaction upon irradiation with an ultraviolet light from an LED.

Examples of sensitizers include amines, such as trimethylamine, methyldimethanolamine, triethanolamine, p-diethylaminoacetophenone, ethyl p-dimethylaminobenzoate, isoamyl p-dimethylaminobenzoate, and N,N-dimethylbenzylamine. These sensitizers can be used individually or in combination of two or more types.

It is preferred that the sensitizer is incorporated in an amount in the range of from 0.05 to 10% by weight, based on the weight of the ultraviolet curing ink composition. When the amount of the sensitizer incorporated falls within the above range, it is possible to cause the photopolymerization initiator to efficiently initiate a reaction.

(Other Additives)

The ultraviolet curing ink may contain, if necessary, an additive other than the above-mentioned additives, such as an anti-foaming agent, a pigment dispersant, a slip agent, a leveling agent, or a polymerization inhibitor.

Further, for controlling the drying rate of the applied ultraviolet curing ink, for example, a non-reactive organic solvent, such as acetone, ethyl acetate, hexane, or cyclohexane, can be added in a small amount to the ultraviolet curing ink.

The ultraviolet curing ink of the invention is advantageous not only in that the ink is improved in weathering resistance by the ultraviolet light absorber but also in that the ink can be advantageously cured by irradiation with an ultraviolet light having the adjusted wavelength. Therefore, the ultraviolet curing ink of the invention and the printing method of the invention are also suitable for printing leaflets for outdoor advertising and the like.

(Additional Remarks)

The printing method of the invention comprises: an ink application step for applying an ultraviolet curing ink onto a recording medium 1, wherein the ultraviolet curing ink contains an ultraviolet light absorber 4 having a transmittance with respect to an ultraviolet light having a wavelength of 360 nm or more, which is higher than a transmittance with respect to an ultraviolet light having a wavelength of less than 360 nm; and an ultraviolet light irradiation step for irradiating the ink on the recording medium 1 with an ultraviolet light having a wavelength of from 365 to 410 nm from an LED.

In the above-mentioned construction, in the ink application step, an ultraviolet curing ink is applied onto a recording medium 1 to form an ink layer 2. Then, in the ultraviolet light irradiation step, the ultraviolet curing ink applied onto the recording medium 1 in the ink application step is irradiated with an ultraviolet light having a wavelength of from 365 to 410 nm using an LED.

The ultraviolet curing ink applied in the ink application step contains an ultraviolet light absorber 4, and the ultraviolet light absorber 4 has a transmittance with respect to an ultraviolet light having a wavelength of 360 nm or more, which is higher than a transmittance with respect to an ultraviolet light having a wavelength of less than 360 nm. Therefore, in the ultraviolet light irradiation step, the ultraviolet light emitted from an LED is not absorbed by the ultraviolet light absorber 4 but transmitted to advantageously cure the ink on the recording medium 1. On the other hand, an ultraviolet light having a wavelength of less than 360 nm is absorbed by the ultraviolet light absorber 4, so that the applied ink can be prevented from suffering deterioration due to an ultraviolet light after the printing.

The printing method of the invention comprises: a first ink application step for applying an ultraviolet curing ink onto a recording medium 1; a first ultraviolet light irradiation step for irradiating the ultraviolet curing ink applied onto the recording medium 1 with an ultraviolet light; a second ink application step for, after the first ultraviolet light irradiation step, applying an ultraviolet curing ink onto the ultraviolet curing ink irradiated with the ultraviolet light; and a second ultraviolet light irradiation step for irradiating the ultraviolet curing ink applied in the second ink application step with an ultraviolet light, wherein the ultraviolet curing ink applied in at least one step of the first ink application step and the second ink application step contains an ultraviolet light absorber 4 having a transmittance with respect to an ultraviolet light having a wavelength of 360 nm or more, which is higher than a transmittance with respect to an ultraviolet light having a wavelength of less than 360 nm, wherein, among the first ultraviolet light irradiation step and the second ultraviolet light irradiation step, in the step of irradiating the ultraviolet curing ink containing the ultraviolet light absorber 4 with an ultraviolet light, the ultraviolet curing ink is irradiated with an ultraviolet light having a wavelength of from 365 to 410 nm, preferably a wavelength of from 380 to 410 nm, from an LED.

In the above-mentioned construction, in the first ink application step and first ultraviolet light irradiation step, the first ink layer 2 is formed and then, in the second ink application step and second ultraviolet light irradiation step, the second ink layer 3 is formed on the first ink layer 2. The ultraviolet curing ink applied in at least one step of the first ink application step and the second ink application step contains an ultraviolet light absorber 4 having a transmittance with respect to an ultraviolet light having a wavelength of 360 nm or more, which is higher than a transmittance with respect to an ultraviolet light having a wavelength of less than 360 nm, and the ultraviolet curing ink containing the ultraviolet light absorber 4 is irradiated with an ultraviolet light having a wavelength of from 365 to 410 nm from an LED.

Thus, in the ultraviolet light irradiation step, the ultraviolet light emitted from an LED is not absorbed by the ultraviolet light absorber 4 but transmitted to advantageously cure the ink on the recording medium 1. On the other hand, an ultraviolet light having a wavelength of less than 360 nm is absorbed by the ultraviolet light absorber 4, so that the applied ink can be prevented from suffering deterioration due to an ultraviolet light after the printing.

Further, for example, when forming the first ink layer 2 from an ultraviolet curing ink containing a pigment and forming the second ink layer 3 from an ultraviolet curing ink containing no pigment, the second ink layer 3 functions as a clear coat, making it possible to prevent the pigment present in the first ink layer from suffering oxidation due to ozone or the like.

In the printing method of the invention, the ultraviolet light absorber 4 may be at least one member selected from the group consisting of a benzotriazole ultraviolet light absorber, a liquid ultraviolet light absorber, a triazine ultraviolet light absorber, a benzophenone ultraviolet light absorber, and a benzoate ultraviolet light absorber.

By virtue of the above-mentioned construction, there can be advantageously constructed an ultraviolet curing ink which is advantageous not only in that the ink can be advantageously cured by irradiation with an ultraviolet light during the printing, but also in that the applied ink can be prevented from suffering deterioration due to an ultraviolet light after the printing.

In the printing method of the invention, the ultraviolet curing ink may contain a diluent in an amount of 20% by weight or more, based on the weight of the ink.

By virtue of the above-mentioned construction, the ultraviolet curing ink has a preferred viscosity such that the cured ink layer 2 and ink layer 3 have advantageous hardness.

The ink-jet printing ink of the invention contains an ultraviolet curing resin, and an ultraviolet light absorber 4 having a transmittance with respect to an ultraviolet light having a wavelength of 360 nm or more, which is higher than a transmittance with respect to an ultraviolet light having a wavelength of less than 360 nm.

By virtue of having the above-mentioned construction, the ink-jet printing ink can be advantageously used in the printing method of the invention.

The present invention is not limited to the above-descried embodiments, and can be modified or changed within the range shown in the appended claims, and embodiments obtained by appropriately combining technical means respectively disclosed in the different embodiments are included in the technical scope of the present invention.

The present invention can be applied to ink-jet printing.

What is claimed is:

1. A printing method comprising:
an ink application step for applying an ultraviolet curing ink onto a recording medium, the ultraviolet curing ink containing an ultraviolet light absorber having a transmittance with respect to an ultraviolet light having a wavelength of 360 nm or more, which is higher than a transmittance with respect to an ultraviolet light having a wavelength of less than 360 nm; and
an ultraviolet light irradiation step for irradiating the ink on the recording medium with an ultraviolet light having a wavelength of from 365 to 410 nm from an LED.

2. A printing method comprising:
a first ink application step for applying an ultraviolet curing ink onto a recording medium;
a first ultraviolet light irradiation step for irradiating the ultraviolet curing ink applied onto the recording medium with an ultraviolet light;
a second ink application step for, after the first ultraviolet light irradiation step, applying an ultraviolet curing ink onto the ultraviolet curing ink irradiated with the ultraviolet light; and
a second ultraviolet light irradiation step for irradiating the ultraviolet curing ink applied in the second ink application step with an ultraviolet light, wherein
the ultraviolet curing ink applied in at least one step of the first ink application step and the second ink application step contains an ultraviolet light absorber having a transmittance with respect to an ultraviolet light having a wavelength of 360 nm or more, which is higher than a transmittance with respect to an ultraviolet light having a wavelength of less than 360 nm, and
among the first ultraviolet light irradiation step and the second ultraviolet light irradiation step, in the step of irradiating the ultraviolet curing ink containing the ultraviolet light absorber with an ultraviolet light, the ultraviolet curing ink is irradiated with an ultraviolet light having a wavelength of from 365 to 410 nm from an LED.

3. The printing method according to claim 1, wherein the ultraviolet light absorber is at least one member selected from the group consisting of a benzotriazole ultraviolet light absorber, a liquid ultraviolet light absorber, a triazine ultraviolet light absorber, a benzophenone ultraviolet light absorber, and a benzoate ultraviolet light absorber.

4. The printing method according to claim 1, wherein the ultraviolet curing ink contains a diluent in an amount of 20% by weight or more, based on the weight of the ink.

5. An ink-jet printing ink containing an ultraviolet curing resin, and an ultraviolet light absorber having a transmittance with respect to an ultraviolet light having a wavelength of 360 nm or more, which is higher than a transmittance with respect to an ultraviolet light having a wavelength of less than 360 nm.

6. The printing method according to claim 2, wherein the ultraviolet light absorber is at least one member selected from the group consisting of a benzotriazole ultraviolet light absorber, a liquid ultraviolet light absorber, a triazine ultraviolet light absorber, a benzophenone ultraviolet light absorber, and a benzoate ultraviolet light absorber.

7. The printing method according to claim 2, wherein the ultraviolet curing ink contains a diluent in an amount of 20% by weight or more, based on the weight of the ink.

8. The printing method according to claim 3, wherein the ultraviolet curing ink contains a diluent in an amount of 20% by weight or more, based on the weight of the ink.
